(19) United States
(12) Patent Application Publication
(10) Pub. No.: US 2025/0307026 A1
(43) Pub. Date: Oct. 2, 2025

(54) DYNAMICALLY CHANGING CPU FEATURES OF VIRTUAL CENTRAL PROCESSING UNITS

(71) Applicant: International Business Machines Corporation, Armonk, NY (US)

(72) Inventors: Qi LIANG, Shanghai (CN); Li Ping HAO, Beijing (CN); Cheng Cheng DONG, Beijing (CN); Hao Jue WANG, Beijing (CN); Xiao Feng REN, Beijing (CN); Dong MA, Beijing (CN)

(21) Appl. No.: 18/622,938

(22) Filed: Mar. 30, 2024

(51) Int. Cl. G06F 9/50

(52) U.S. Cl. CPC G06F 9/5077; G06F 9/5033; G06F 9/505

(57) ABSTRACT

A cloud management component may detect a request associated with a new workload to be executed by a virtual machine deployed on a core of a central processing unit (CPU). The virtual machine may utilize a first virtual CPU (vCPU) and a second vCPU of the core. CPU feature may be enabled on the first vCPU and the second vCPU. An existing workload may utilize the CPU feature enabled on the first vCPU. The new workload is to be executed with the second vCPU without utilizing the CPU feature. The cloud management component may provide an instruction to disable the CPU feature enabled on the second vCPU. The cloud management component may configure an instruction intercept, for the second vCPU, to prevent execution of one or more instructions that cause the CPU feature to be executed by the second vCPU.

### BACKGROUND

The present invention relates to virtualization of virtual processing units (CPUs), and for example, relates to changing features of virtual CPUs utilized by virtual machines.

Virtualization of a CPU involves a single CPU acting as multiple separate CPUs. The underlying physical resources are used whenever possible and a virtualization layer runs instructions only needed to make virtual machines operate as if they were running directly on a physical machine.

### SUMMARY

In some implementations, a method comprising: detecting a request associated with a new workload to be executed by a virtual machine deployed on a core of a central processing unit (CPU), wherein the virtual machine utilizes a first virtual CPU (vCPU) and a second vCPU of the core, wherein a CPU feature is enabled on the first vCPU and the second vCPU, wherein an existing workload utilizes the CPU feature enabled on the first vCPU, wherein the new workload is to be executed with the second vCPU without utilizing the CPU feature; providing an instruction to disable the CPU feature enabled on the second vCPU; configuring an instruction intercept, for the second vCPU, to prevent execution of one or more instructions that cause the CPU feature to be executed by the second vCPU; and causing the new workload to be executed by the second vCPU of the virtual machine after providing the instruction to disable the CPU feature and configuring the instruction intercept.

In some implementations, a computer program product comprising: one or more computer readable storage media, and program instructions collectively stored on the one or more computer readable storage media, the program instructions comprising: program instructions to detect a request associated with a central processing unit (CPU) feature associated with a virtual CPU (vCPU) of a CPU, wherein the CPU feature is associated with a virtual machine; program instructions to disable the CPU feature on the vCPU and configure an instruction intercept to prevent execution of the CPU feature by the vCPU when the request indicates that the CPU feature is to be disabled; program instructions to enable the CPU feature on the vCPU and remove an instruction intercept that prevents execution of the CPU feature by the vCPU when the request indicates that the CPU feature is to be enabled; and program instructions to adjust a number of vCPUs associated with the virtual machine.

In some implementations, a system comprising: a cloud management component to: detect a request associated with a central processing unit (CPU) feature associated with a virtual CPU (vCPU) of a CPU, wherein the CPU feature is associated with a virtual machine; disable the CPU feature on the vCPU and configure an instruction intercept to prevent execution of the CPU feature by the vCPU when the request indicates that the CPU feature is to be disabled; enable the CPU feature on the vCPU when the request indicates that the CPU feature is to be enabled; and determine whether to adjust a number of vCPUs associated with the virtual machine.

### BRIEF DESCRIPTION OF THE DRAWINGS

FIG. 1 is a diagram of an example implementation described herein.

FIGS. 2A-2H are diagrams of an example implementation described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with dynamically changing central processing unit (CPU) features of virtual CPUs.

### DETAILED DESCRIPTION

The following detailed description of example implementations refers to the accompanying drawings. The same reference numbers in different drawings may identify the same or similar elements.

A virtual machine (VM) may refer to a compute resource that uses software instead of a physical computer to execute programs. For example, the virtual machine (also referred to as “guest machine”) may execute an operating system on a physical machine (also referred to as “physical machine”). The virtual machine may emulate the physical machine. The virtual machine may implement a guest environment while the physical machine may implement a host environment. Multiple virtual machines may execute separate operating systems on the physical machine.

In some examples, a hypervisor (also referred to a virtual machine monitor (VMM) may emulate a client/server central processing unit (CPU), memory, hard disk, network and other hardware resources. Such emulation enables the hypervisor to emulate multiple virtual hardware platforms that are isolated from each other, thus allowing multiple different virtual machines to run multiple different OSs on the same underlying physical machine.

A virtual machine may utilize a virtual CPU to execute (or process) various workloads. As used herein, a “workload” may be used to refer to a function, a task, among other examples of operations performed by a processor. A vCPU may represent a portion of a physical CPU, of the physical machine, that is assigned to the VM. The virtual CPU (or vCPU) may implement a feature of one or more features supported by a core of the CPU. In some examples, the feature may include a hardware accelerator (also referred to as “accelerator”). An “accelerator,” as used herein, may refer to device or circuit that performs a specific task in a computer system more efficiently than the general-purpose computer system. An accelerator may be used to accelerate a workload (or a task). As an example, an artificial intelligence (AI) accelerator may be used to accelerate an AI workload. A compression accelerator may be used to accelerate a compression workload.

In some implementations, the core of the CPU or the CPU may include an accelerator on chip, like an artificial intelligence (AI) accelerator and/or a compression accelerator. The accelerators may be included on the CPU. For example, one accelerator may be included on a core. Alternatively, another accelerator may be on the CPU and may be shared by multiple cores.

In a cloud environment, different workloads may be executed. One workload may utilize an accelerator while another workload may not utilize an accelerator. Current virtualization for a CPU (or CPU virtualization) assign vCPUs with the same features to a virtual machine. For example, the virtual machine may be assigned to vCPUs with accelerators or may be assigned to vCPUs without accelerators.

In some situations, a virtual machine may switch from executing (or performing) a workload that does not utilize an AI accelerator to executing a workload that does utilize an AI accelerator. Currently, in order to perform the switch, the virtual machine is to be initially shut down. After shutting down, the virtual machine may be moved to a physical machine with a CPU that supports the AI accelerator. Alternatively, after shutting down, the virtual machine may be instantiated with vCPUs of a core that supports the AI accelerator (e.g., on-chip accelerator enabled).

Shutting down and restarting the virtual machine in this manner negatively affect a performance of the workload. Accordingly, a need exists to switch a virtual machine between a workload utilizing an accelerator to a workload not utilizing an accelerator without disrupting an operation of the virtual machine.

Implementations described herein are directed to dynamically changing CPU features, utilized by a virtual machine, without shutting down the virtual machine. For example, implementations described herein are directed to a cloud management component enabling a CPU feature and disabling a CPU feature without shutting down the virtual machine. As an example, the CPU feature may include an accelerator feature of an accelerator. For instance, the accelerator may include an AI accelerator and/or a compression accelerator.

In some examples, the CPU feature may be enabled for the virtual machine. Alternatively, the CPU feature may be disabled for the virtual machine. The virtual machine may be executing on a core of a CPU of a physical machine. The accelerator may be included on the core of the CPU. Alternatively, the accelerator may be included on the CPU and shared by multiple cores of the CPU. In some implementations, the operations described herein may be performed by a cloud management component (e.g., including a cloud management software).

When enabling the CPU feature, the virtual machine may be initially executed without the CPU feature. The cloud management component may detect a request to enable the CPU feature on a vCPU of the virtual machine. For example, a user may provide a request to upgrade the vCPU to include the CPU feature. Based on detecting the request. the cloud management component may invoke (or provide) an instruction to enable the CPU feature on the vCPU. The cloud management component may remove an instruction intercept that may prevent execution of the CPU feature in the virtual machine (e.g., that may prevent the virtual machine from utilizing the CPU feature).

The cloud management component may rebalance CPU virtualization of vCPUs of the core. For example, the cloud management component may determine whether a number of vCPUs, of the core, with the CPU feature has satisfied a vCPU number threshold for the core. If the cloud management component determines that the number of vCPUs with the CPU feature has satisfied the vCPU number threshold, the cloud management component may assign the vCPU with the CPU feature enabled to a different core of the CPU. For example, if the cloud management component determines that the number of vCPUs with the CPU feature exceeds the vCPU number threshold, the cloud management component may assign the vCPU with the CPU feature enabled to a different core of the CPU.

When disabling the CPU feature, the cloud management component may detect a request to disable the CPU feature on a vCPU of the virtual machine. For example, a user may provide a request to downgrade the vCPU to remove the CPU feature. Based on detecting the request. The cloud management component may invoke (or provide) an instruction to disable the CPU feature on the vCPU. The cloud management component may configure an instruction intercept that may prevent execution of the CPU feature in the virtual machine (e.g., that may prevent the virtual machine from utilizing the CPU feature). The instruction intercept may prevent the CPU feature from executing inside an environment of the virtual machine.

The cloud management component may rebalance CPU virtualization of vCPUs of the core. For example, the cloud management component may consolidate vCPUs of the virtual machine to a small number of CPU cores to improve cache efficiency. For example, the cloud management component may assign the vCPUs to a number threshold of cores of the CPU (e.g., may assign the vCPUs to a particular number of cores of the CPU).

An advantage of dynamically changing CPU features as described herein is efficient use of accelerators in a cloud environment. An additional advantage of dynamically changing CPU features as described herein is to prevent shutting the virtual machine when changing the CPU features. Accordingly, another additional advantage of dynamically changing CPU features this manner is to conserve computational resources that would have been used to shut down and restart the virtual machine.

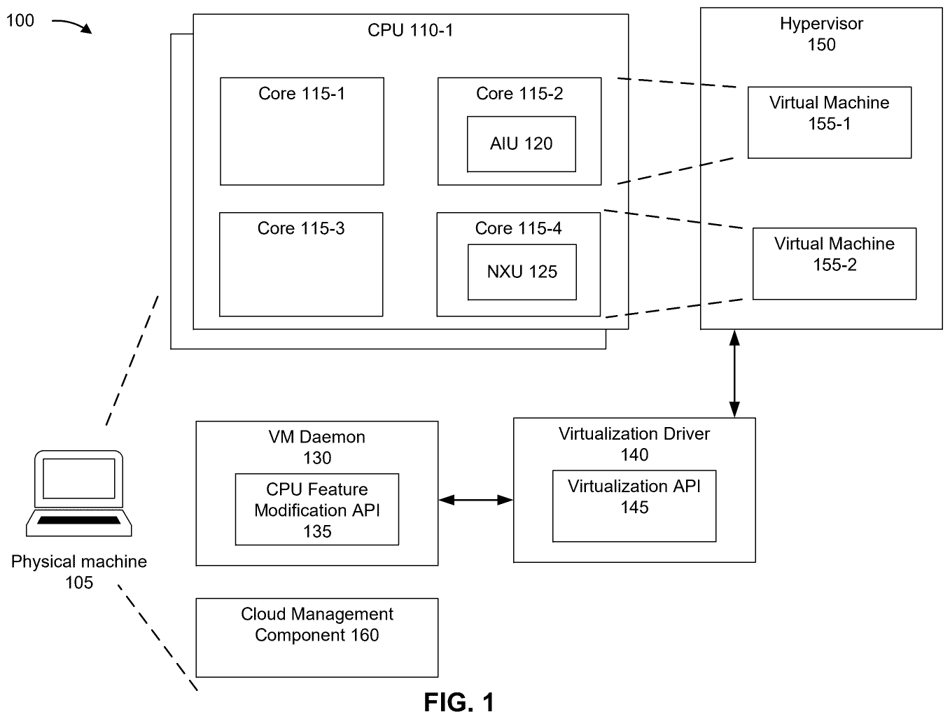

FIG. 1 is a diagram of an example implementation 100 described herein. As shown in FIG. 1, example implementation 100 includes a physical machine 105. Physical machine 105 may include a desktop computer, a laptop computer, a tablet computer, a smart phone, a mainframe computer, a quantum computer, among other examples of computers or mobile devices. As shown in FIG. 1, physical machine 105 may include one or more CPUs, such as CPU 110-1, CPU 110-2, and so on (collectively “CPUs 110”).

As shown in FIG. 1, CPU 110-1 may include multiple cores, such as core 115-1, core 115-2, core 115-3, core 115-4, and so on (collectively “cores 115” and individually “core 115”). In some situations, a core 115 may include an accelerator. For example, core 115-2 may include AIU 120 and core 115-4 may include NXU 125. In this regard, AIU 120 may be referred to as an in-core accelerator. AIU 120 may include an AI accelerator and NXU 125 may include a compression accelerator. In some implementations, cores 115 may have same structures. For examples, cores 115 may include AIU 120 without including NXU 124. In some implementations, CPU 110-1 may include AIU 120 and cores 115 may share AIU 120. In this regard, AIU 120 may be referred to an in-chip accelerator.

As shown in FIG. 1, physical machine 105 may include a VM daemon 130 and a virtualization driver 140. As an example, VM daemon 130 may include a daemon that creates and terminates virtual machine instances (e.g., via an application program interface (API) of a hypervisor). The virtual machine instances may launch (or initialize) applications on virtual machines.

VM daemon 130 may include a CPU feature modification API 135. In some examples, CPU feature modification API 135 may include an API that may be used to modify CPU features, of a vCPU, dynamically. For example, CPU feature modification API 135 may enable the use of a command prompt to enable and disable the CPU feature of the vCPU. The CPU feature may be enabled and disabled without shutting down (or terminating) a virtual machine that uses the vCPU. The CPU feature may be available on a CPU 110 and/or a core 115 associated with the vCPU. The CPU feature may include an accelerator, such as an AI accelerator, a compression accelerator, among other examples.

In some examples, CPU feature modification API 135 may include an API that may be used to determine CPU features available on a CPU 110 and/or a core 115. For example, CPU feature modification API 135 may enable the use of a command prompt to determine the CPU features available on a CPU 110 and/or a core 115.

In some examples, virtualization driver 140 may include virtualization drivers that communicate with different virtualization platform. As shown in FIG. 1, virtualization driver 140 may include a virtualization API 145. Virtualization API 145 may include an API that is used to modify CPU features dynamically by providing (or issuing) an instruction to enable and disable the CPU features of a vCPU. The CPU feature may be enabled and disabled without shutting down (or terminating) a virtual machine that uses the vCPU.

As shown in FIG. 1, physical machine 105 may include a hypervisor 150. Hypervisor 150 (or virtual machine monitor) may create, manage, and virtual machines. For example, hypervisor 150 may instantiate the virtual machines and may terminate (or shut down) the virtual machines. As shown in FIG. 1, hypervisor 150 may instantiate virtual machine 155-1, virtual machine 155-2, and so on (collectively “virtual machines 155” and individually “virtual machine 155”).

As shown in FIG. 1, core 115-2 may provide computing resources for virtual machine 155-1 and core 115-4 may provide computing resources for virtual machine 155-2. In other words, virtual machine 155-1 may be deployed on (or deployed using) core 115-2 and virtual machine 155-2 may be deployed on (or deployed using) core 115-4. In some situations, VM daemon 130, virtualization driver 140, and hypervisor 150 may communicate information that may be used to create and terminate virtual machines 155.

In some examples, physical machine 105 may implement compute service components, such a Nova service in OpenStack®. For example, VM daemon 130 may correspond to nova-compute, virtualization driver may correspond to LibVirt, and hypervisor 150 may correspond to a Kernel-based Virtual Machine (KVM). As an example, the instruction KVM KVM_SET_CPUID2 may correspond to the instruction to disable or enable the CPU feature.

As shown in FIG. 1, physical machine 105 may include cloud management component 160. Cloud management component 160 may include one or more devices that facilitate dynamically changing CPU features of vCPUs without shutting down a virtual machine, as described herein.

As indicated above, FIG. 1 is provided as an example. Other examples may differ from what is described with regard to FIG. 1. The number and arrangement of devices shown in FIG. 1 are provided as an example. A network, formed by the devices shown in FIG. 1 may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

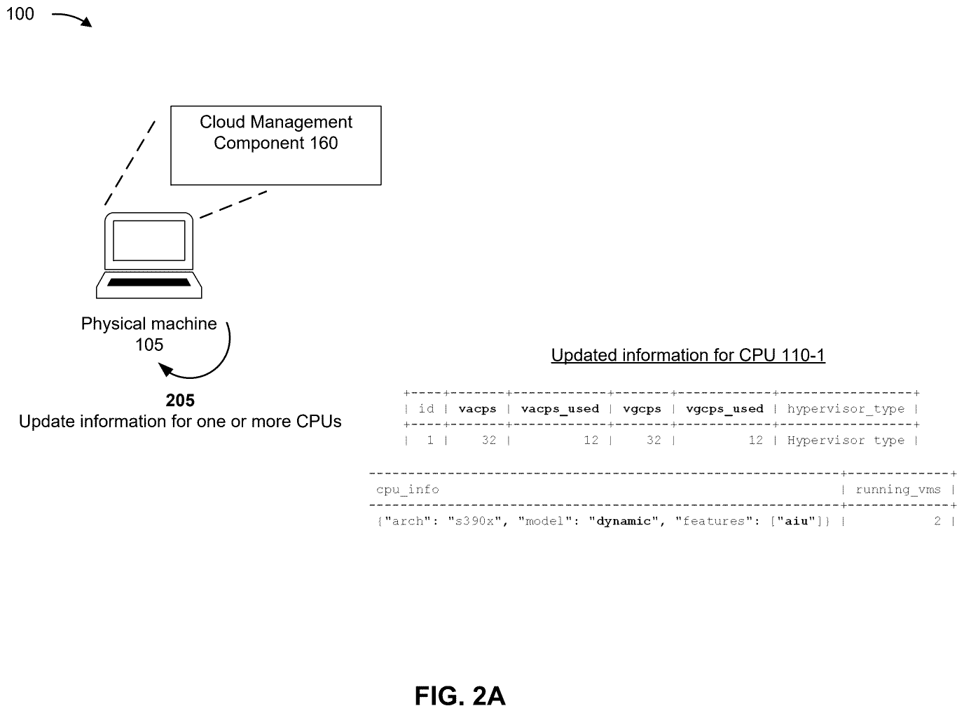

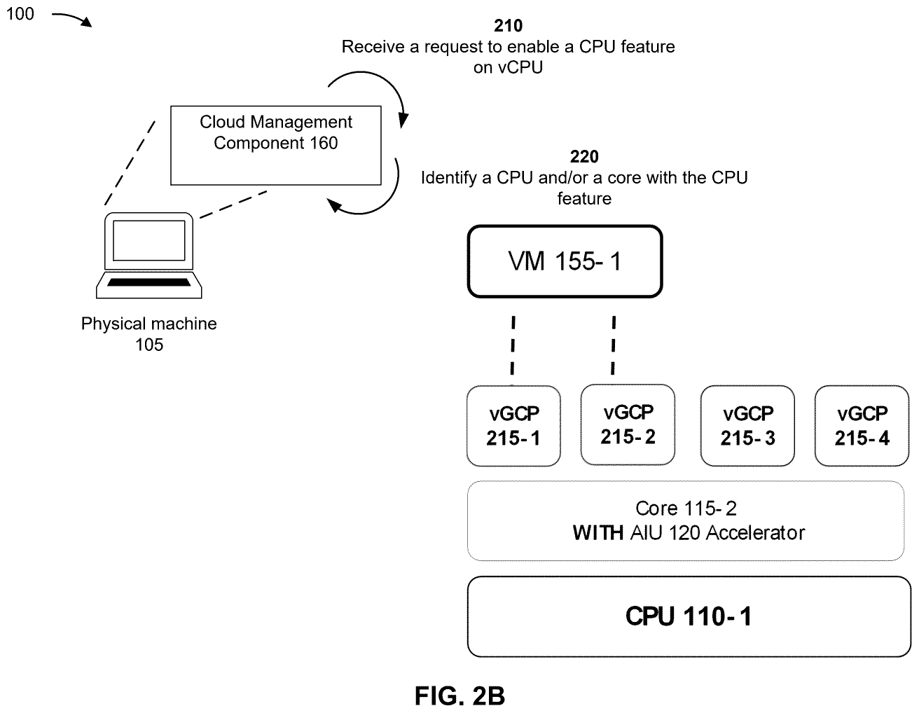

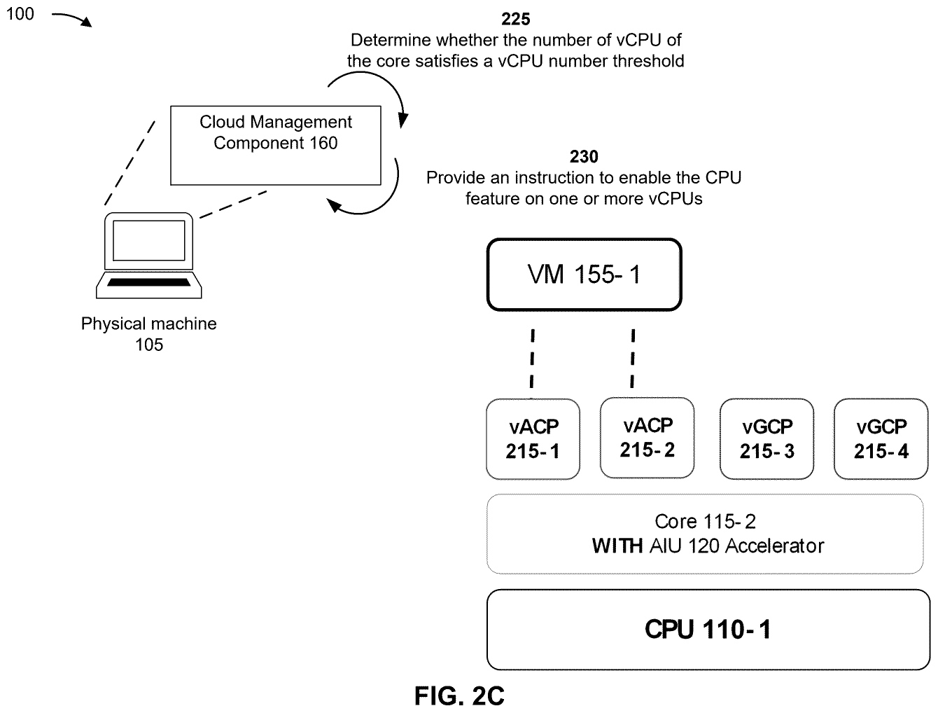

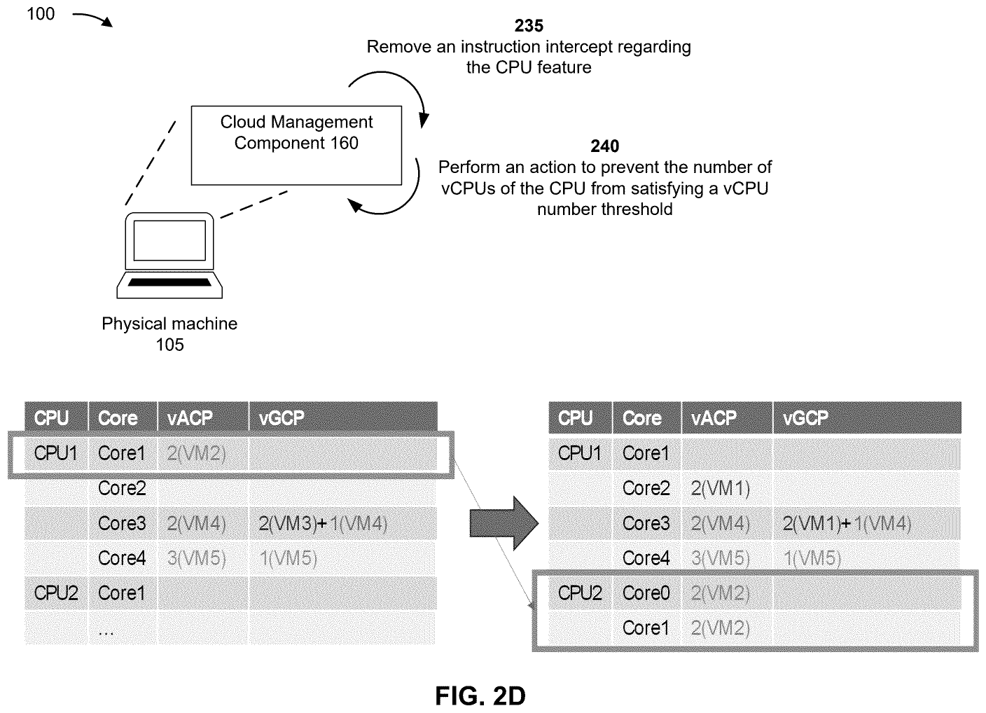

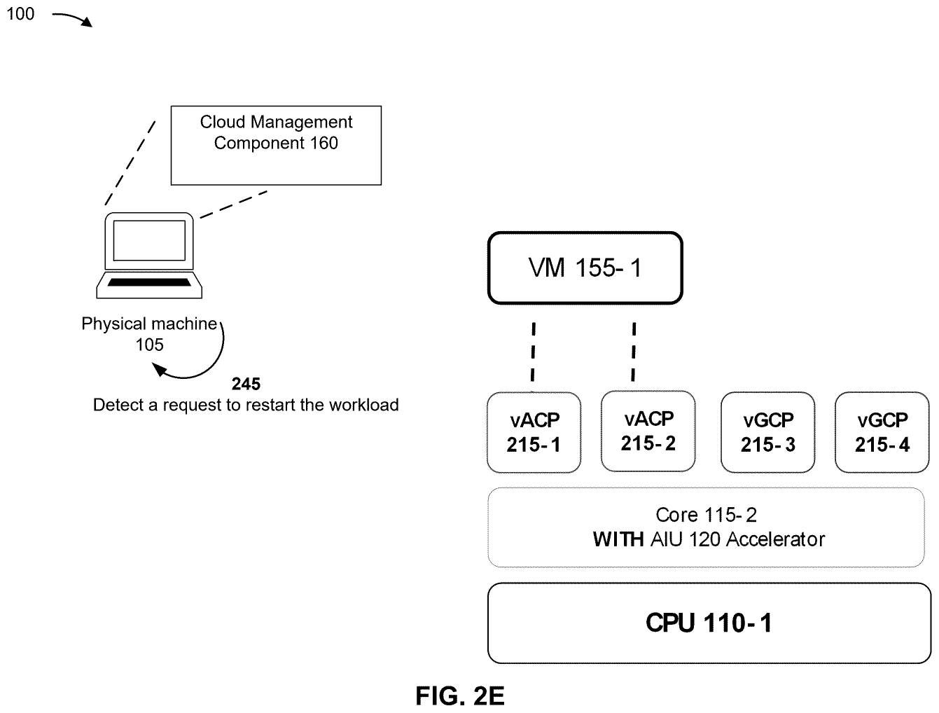

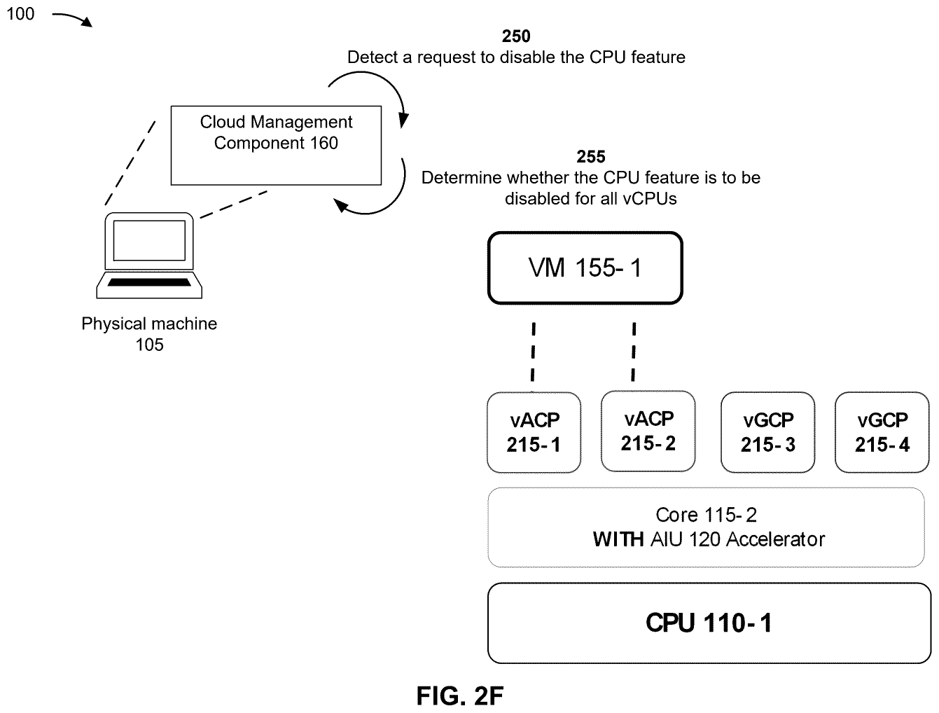

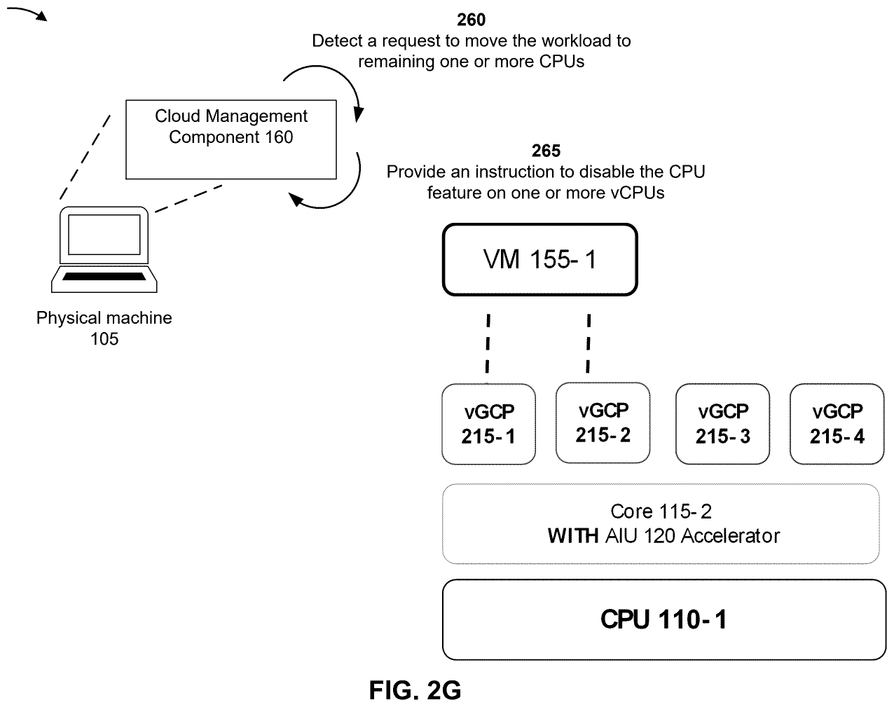

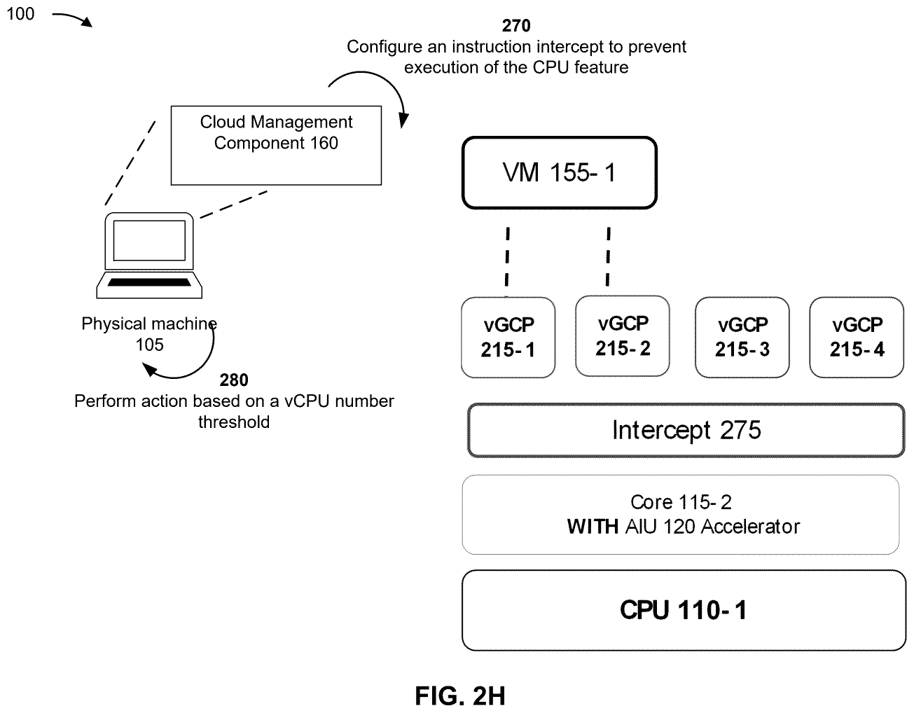

FIGS. 2A-2H are diagrams of an example implementation 200 described herein. As shown in FIGS. 2A-2H, example implementation 200 includes a physical machine 105. As shown in FIG. 2A, and by reference number 205, physical machine 105 may update information for one or more CPUs of physical machine 105. In some implementations, physical machine 105 may store vCPU type/number information in a database associated with the compute service components (e.g., in a Nova database). For example, physical machine 105 may store information regarding vACP and vGCP into the CPU information of physical machine 105 in the database. vACP may include a vCPU with an AI accelerator and vGCP may include a vCPU without an accelerator.

PHYSICAL MACHINE 105 may specify cpu model as “dynamic” and add “aiu” into a feature list of the CPU. In some situations, vACP and vGCP can have different over-allocation ratio. In some examples, updating the information for the one or more CPUs may facilitate the CPU features of vCPUs being enabled or disabled without shutting a machine learning model.

As shown in FIG. 2B, and by reference number 210, cloud management component 160 may receive a request to enable a CPU feature on a vCPU. For example, a user of physical machine 105 may desire to initiate a workload that involves AI computations. The user may desire the workload to be performed on a virtual machine. Accordingly, the user may submit the request to enable the CPU feature on a vCPU. The CPU feature may include an AI accelerator.

As shown in FIG. 2B, and by reference number 220, cloud management component 160 may identify a CPU and/or a core with the CPU feature. In some examples, cloud management component 160 may perform a search of the database to identify a CPU and/or a core with the CPU feature. For example, based on the search, cloud management component 160 may determine that CPU 110-1 includes core 115-2. Accordingly, cloud management component 160 may determine that the workload is to be performed using a virtual machine that use one or more vCPUs of core 115-2.

As shown in FIG. 2B, virtual machine 155-1 may be deployed to use the computing resources of a vGCP 215-1 and a vGCP 215-2. vGCP 215-1 and vGCP 215-2 may include vCPUs of core 115-2. Such vCPUs of core 115-2 may be provided without an AI accelerator. In other words, while core 115-2 may include the CPU feature, the CPU feature may be disabled on vGCP 215-1 and vGCP 215-2. As shown in FIG. 2B, the computing resources of core 115-2 may be virtualized into multiple vCPUs, such vGCP 215-1, vGCP 215-2, a vGCP 215-3, and a vGCP 215-4.

As shown in FIG. 2C, and by reference number 225, cloud management component 160 may determine whether the number of vCPUs of the core satisfies a vCPU number threshold (e.g., whether the number of vCPUs of the core exceeds the vCPU number threshold). In some examples, the vCPU number threshold may indicate a particular number of vCPUs, with the CPU feature enabled, that ensures the core to function efficiently. In this regard, cloud management component 160 may determine whether the number of vCPUs, with the CPU enabled, for core 115-2 satisfies the vCPU number threshold for core 115-2.

If cloud management component 160 determines that the number of vCPUs satisfies the vCPU number threshold for core 115-2, cloud management component 160 may cause one or more of the vCPUs to be moved to a different core. Additionally, cloud management component 160 may cause one or more virtual machines, utilizing the one or more vCPUs, to be moved to the different core.

As shown in FIG. 2C, and by reference number 230, cloud management component 160 may provide an instruction to enable the CPU feature on one or more vCPUs. For example, cloud management component 160 may provide an instruction to enable the CPU feature on one or more vCPUs of core 115-2. In some implementations, cloud management component 160 may invoke a function (e.g., may make an API call) to enable the CPU feature. Cloud management component 160 may invoke the CPU feature using CPU feature modification API 135 and/or virtualization API 145. In some instances, cloud management component 160 may cause CPU 110-1 to provide the instruction to enable the CPU feature. The instruction may enable the CPU feature to be used by virtual machine 155-1 to execute the workload.

In some examples, in the event the Nova service in OpenStack® has been deployed on physical machine 105, the CPU feature on one or more vCPUs of core 115-2 may be enabled using an API call, such as by using KVM API, KVM_SET_CPUID2. The API call (or instruction) may be used to define the vCPU responses to the CPUID instruction. The virtual machine can observe CPU features vCPU change. On an IBM Z Processor, software can query CPU facility bits to know whether one CPU facility is installed. CPU facility bits can be stored by the STORE FACILITY LIST (STFL) and STORE FACILITY LIST EXTENDED (STFLE) instructions. If the vector facility for z/Architecture is not installed, an operation exception is recognized. On an X86 computer architecture, a CPUID instruction may be used to query CPU features. A result of the query may indicate whether the CPU features are available.

As shown in FIG. 1C, based on the instruction, the CPU feature may be enabled on one or more vCPUs, such as vGCP 215-1 and vGCP 215-2 which have become vACP 215-1 and vACP 215-2. In other words, based on the instructions, the AI accelerator feature may be enabled on vGCP 215-1 and vGCP 215-2.

As shown in FIG. 2D, and by reference number 235, cloud management component 160 may remove an instruction intercept regarding the CPU feature. For example, after enabling the CPU feature on one or more vCPUs, cloud management component 160 may remove the instruction intercept to prevent an instruction that executes the CPU feature from intercepted, thereby enabling the CPU feature to be used by virtual machine 155-1 to execute the workload.

As shown in FIG. 2D, and by reference number 240, cloud management component 160 may perform an action to prevent the number of vCPUs of the CPU from satisfying a vCPU number threshold. For example, cloud management component 160 may compare the number of vCPUs, of CPU 110-1, with the CPU feature enabled and the vCPU number threshold for CPU 110-1, with the CPU feature enabled. The number of vCPUs may be the number of vCPUs after enabling the CPU feature on vGCP 215-1 and vGCP 215-2. The vCPU number threshold for CPU 110-1 may be a number of vCPUs with the CPU feature enabled.

As an example, if the number of vCPUs of CPU 110-1, with the CPU feature enabled, satisfies the number threshold of the vCPU with CPU feature enabled, cloud management component 160 may cause one or more vCPUs to be moved to a different core.

In FIG. 2D, assume the vCPU number threshold is 8 per CPU 110 and the vCPU number threshold is 2 per core 115, and referring to vACP in application document. If a request is provided to increase vACP of VM2 from 2 to 4, VM2 may be moved to CPU 110-2 because increasing the current vACP number, from 8 to 10, would satisfy the vCPU number threshold of 8 (e.g., exceed the vCPU number threshold of 8). if the number of vCPUs with the CPU feature enabled is 7, cloud management component 160 may move one or more vCPUs with the CPU feature enabled to a different CPU because enabling the CPU feature on vGCP 215-1 and vGCP 215-2 would bring the number of vCPUs to 9. Accordingly, enabling the CPU feature on vGCP 215-1 and vGCP 215-2 would satisfy the vCPU number threshold. Therefore, as an example, cloud management component 160 may move the vCPUs of core 115-1 to CPU 110-2. Cloud management component 160 may be performed the same action with respect to the number of vCPUs, of a core 115, with the CPU feature enabled, and the vCPU number threshold for the core 115.

As shown in FIG. 2E, and by reference number 245, cloud management component 160 may detect a request to restart the workload. For example, after enabling the CPU feature on vGCP 215-1 and vGCP 215-2, cloud management component 160 may detect a request to restart the workload. The workload may check for updated CPU features without periodically checking for updated CPU features (e.g., one time at start-up). In such instances, the user may provide the request to restart the workload to cause the workload to check for updated CPU features. In some examples, the workload may periodically check for updated CPU features. By checking for updated CPU features, the workload may utilize the CPU feature to efficiently perform one or more portions of the workload. For example, the CPU feature may improve the execution of a specific algorithm of the workload.

As shown in FIG. 2F, and by reference number 250, cloud management component 160 may detect a request to disable the CPU feature. For example, after the workload has been completed, the user may desire to switch from executing (or performing) the workload that utilizes an AI accelerator to executing an additional workload that does not utilize an AI accelerator. Accordingly, the user may provide the request to disable the CPU feature on virtual machine 155-1.

As shown in FIG. 2F, and by reference number 255, cloud management component 160 may determine whether the CPU feature is to be disabled for all vCPUs. For example, after detecting the request to disable the CPU feature, cloud management component 160 may determine whether the CPU feature is to be disabled for all vCPUs with the CPU feature enabled. For instance, cloud management component 160 may determine whether the CPU feature is to be disabled for all vCPUs of core 115-2, for all vCPUs of CPU 110-1, or for one or more vCPUs that are utilized by the workload with remaining one or more vCPUs remaining enabled.

As shown in FIG. 2G, and by reference number 260, cloud management component 160 may detect a request to move the workload to the remaining one or more vCPUs with the CPU feature enabled. For example, if the CPU feature is to be disabled for one or more vCPUs, the user may provide a request to move the workload to the remaining one or more vCPUs with the CPU feature enabled.

As shown in FIG. 2F, and by reference number 265, cloud management component 160 may provide an instruction to disable the CPU feature on the one or more vCPUs. For example, based on detecting the request to disable the vCPU and based on the request indicating that the CPU feature is to be disabled on the one or more vCPUs, cloud management component 160 may provide an instruction to disable the CPU feature on the one or more vCPUs. Cloud management component 160 may provide the instruction in a manner similar to the manner described above in connection with FIG. 2C and reference number 230. For example, cloud management component 160 may provide an instruction to disable the CPU feature on one or more vCPUs of core 115-2.

The instruction may disable the CPU feature from being used by virtual machine 155-1 to execute the additional workload. In some examples, in the event the Nova service in OpenStack® has been deployed on physical machine 105, the instruction may include KVM KVM_SET_CPUID2. As shown in FIG. 2G, as a result of providing the instruction to disable the CPU feature, vACP 215-1 and vACP 215-2 may be changed back to vGCP 215-1 and vGCP 215-2.

As shown in FIG. 2H, and by reference number 270, cloud management component 160 may configure an instruction intercept to prevent execution of the CPU feature. For example, based on the request to disable the CPU feature on the one or more vCPUs, cloud management component 160 may configure parameters of an instruction intercept 275 to prevent execution of the CPU feature in a guest environment of virtual machine 155-1. In some examples, cloud management component 160 may set one or more bits on the instruction intercept to prevent execution of instructions that execute the CPU feature (e.g., prevent execution of instructions that utilize the CPU feature).

As shown in FIG. 2G, the instruction intercept may be provided for all accelerators, including vGCP 215-1 and provided for vGCP 240-2.

As shown in FIG. 2H, and by reference number 280, cloud management component 160 may perform an action based on the vCPU number threshold. In some implementations, cloud management component 160 may consolidate one virtual machine's vCPUs to a small number of cores 115 of CPU 110-1.

As indicated above, FIGS. 2A-2H are provided as an example. Other examples may differ from what is described with regard to FIGS. 2A-2H. The number and arrangement of devices shown in FIG. 1 are provided as an example. A network, formed by the devices shown in FIGS. 2A-2H may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 2A-2H. Furthermore, two or more devices shown in FIGS. 2A-2H may be implemented within a single device, or a single device shown in FIGS. 2A-2H may be implemented as multiple, distributed devices. Additionally, or alternatively, a set of devices (e.g., one or more devices) shown in FIGS. 2A-2H may perform one or more functions described as being performed by another set of devices shown in FIGS. 2A-2H.

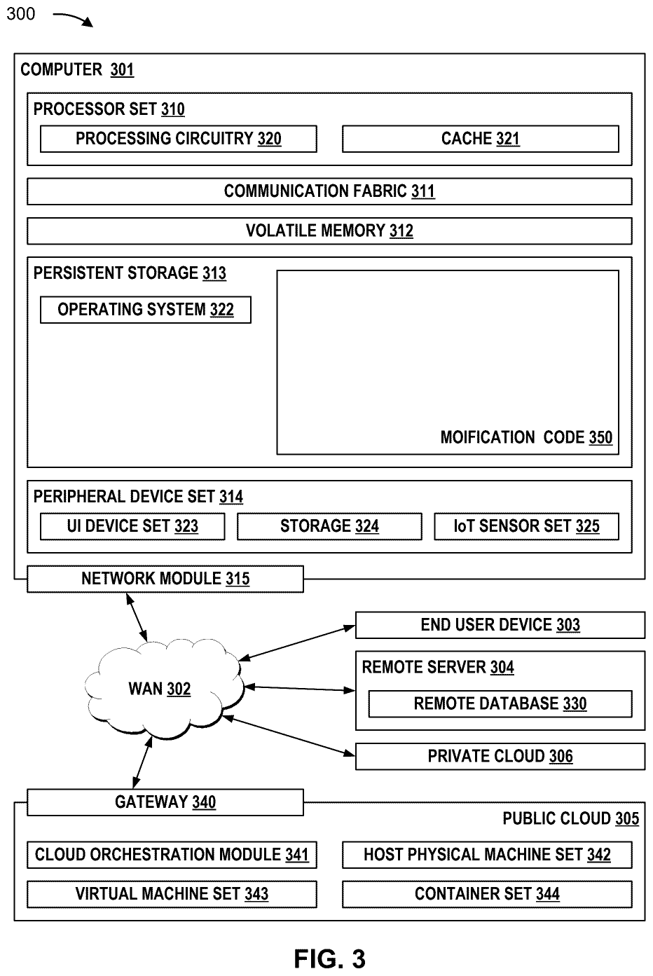

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as modification code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 410 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 321 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 301 to cause a series of operational steps to be performed by processor set 410 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 410 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 430 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

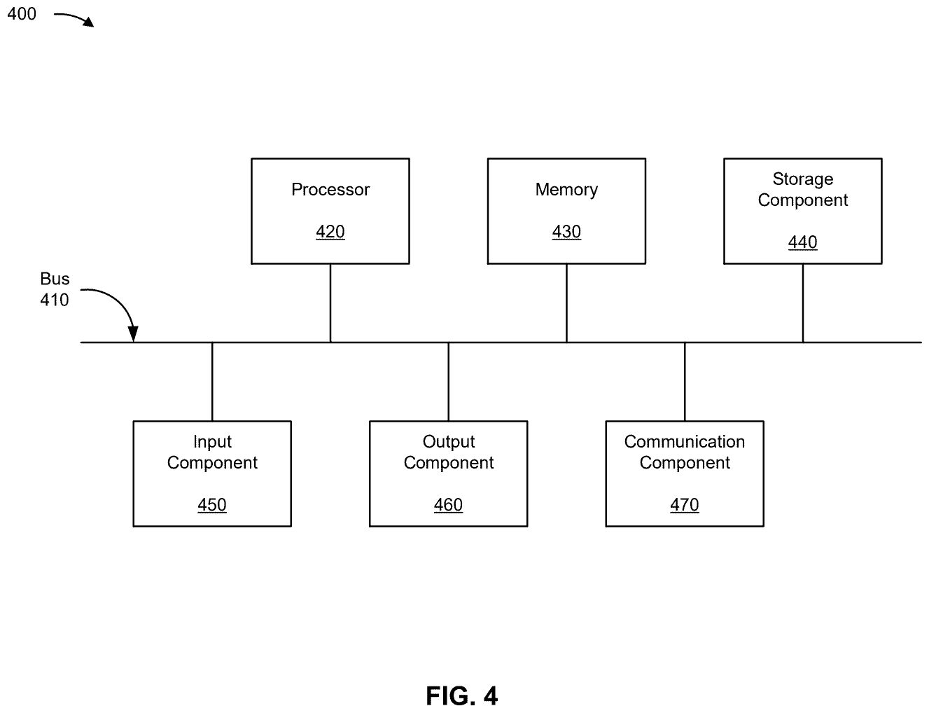

FIG. 4 is a diagram of example components of a device 400, which may correspond to physical machine 105. In some implementations, physical machine 105 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 400 may include additional components, fewer components, different components, or differently arranged components than those shown in FIG. 3. Additionally, or alternatively, a set of components (e.g., one or more components) of device 400 may perform one or more functions described as being performed by another set of components of device 400.

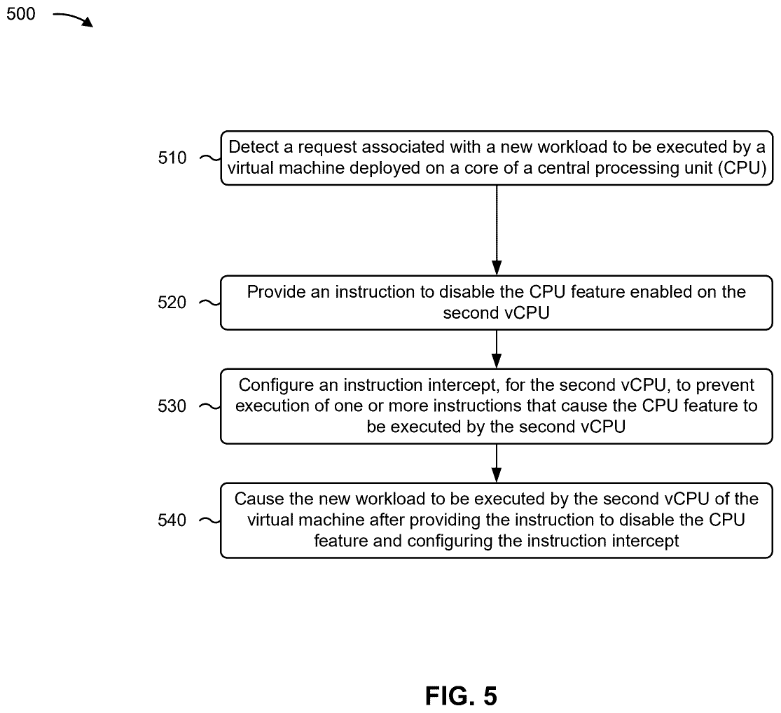

FIG. 5 is a flowchart of an example process 500 associated with dynamically changing cpu features of virtual central processing units. In some implementations, one or more process blocks of FIG. 5 may be performed by a physical machine (e.g., physical machine 105). Additionally, or alternatively, one or more process blocks of FIG. 1 may be performed by one or more components of device 400, such as processor 420, memory 430, storage component 440, input component 450, output component 460, and/or communication component 470.

As shown in FIG. 5, process 500 may include detecting a request associated with a new workload to be executed by a virtual machine deployed on a core of a central processing unit (CPU) (block 510). For example, the device may detect a request associated with a new workload to be executed by a virtual machine deployed on a core of a central processing unit (CPU), wherein the virtual machine utilizes a first virtual CPU (vCPU) and a second vCPU of the core, wherein a CPU feature is enabled on the first vCPU and the second vCPU, as described above. In some implementations, the virtual machine utilizes a first virtual CPU (vCPU) and a second vCPU of the core, wherein a CPU feature is enabled on the first vCPU and the second vCPU, wherein an existing workload utilizes the CPU feature enabled on the first vCPU, wherein the new workload is to be executed with the second vCPU without utilizing the CPU feature.

As further shown in FIG. 5, process 500 may include providing an instruction to disable the CPU feature enabled on the second vCPU (block 520). For example, the device may provide an instruction to disable the CPU feature enabled on the second vCPU, as described above.

As further shown in FIG. 5, process 500 may include configuring an instruction intercept, for the second vCPU, to prevent execution of one or more instructions that cause the CPU feature to be executed by the second vCPU (block 530). For example, the device may configure an instruction intercept, for the second vCPU, to prevent execution of one or more instructions that cause the CPU feature to be executed by the second vCPU, as described above.

As further shown in FIG. 5, process 500 may include causing the new workload to be executed by the second vCPU of the virtual machine after providing the instruction to disable the CPU feature and configuring the instruction intercept (block 540). For example, the device may cause the new workload to be executed by the second vCPU of the virtual machine after providing the instruction to disable the CPU feature and configuring the instruction intercept, as described above.

In some implementations, causing the new workload to be executed comprises causing the new workload to be executed without restarting the virtual machine.

In some implementations, the request is a first request, the existing workload is a first workload, and the new workload is a second workload, and wherein the method further comprises detecting a second request associated with a third workload to be executed by the virtual machine, wherein the third workload is to be executed with the CPU feature, providing an instruction to enable the CPU feature on the second vCPU, removing the instruction intercept to prevent execution of one or more instructions that cause the CPU feature to be executed, and causing the third workload to be executed by the second vCPU of the virtual machine.

In some implementations, the request is a first request, the existing workload is a first workload, and the new workload is a second workload, and wherein the method further comprises detecting a second request associated with a third workload to be executed by the virtual machine, wherein the new workload is to be executed with the CPU feature, providing an instruction to enable the CPU feature on a third vCPU of the core, and causing the third workload to be executed by the third vCPU.

In some implementations, process 500 includes adjusting a number of vCPUs associated with the virtual machine.

In some implementations, adjusting the number of vCPUs comprises assigning the vCPUs to a number threshold of cores of the CPU.

In some implementations, the CPU feature is an accelerator feature of an accelerator.

In some implementations, the accelerator feature is included on the core.

In some implementations, the accelerator feature is shared by multiple cores of the CPU.

In some implementations, process 500 may include detecting a request to enable the CPU feature; and identifying a core, of the CPU, that includes the CPU feature. If no core and/or CPU are identified, the request may be moved to another computing node.

In some implementations, process 500 may include determining whether the number of vCPUs currently instantiated on the core satisfy a vCPU number threshold. In some implementations, process 500 may include instantiating the vCPU on the core based on determining whether the number of vCPUs currently instantiated on the core satisfy the vCPU number threshold.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
detecting a request associated with a new workload to be executed by a virtual machine deployed on a core of a central processing unit (CPU),
wherein the virtual machine utilizes a first virtual CPU (vCPU) and a second vCPU of the core,
wherein a CPU feature is enabled on the first vCPU and the second vCPU,
wherein an existing workload utilizes the CPU feature enabled on the first vCPU,
wherein the new workload is to be executed with the second vCPU without utilizing the CPU feature;
providing an instruction to disable the CPU feature enabled on the second vCPU;
configuring an instruction intercept, for the second vCPU, to prevent execution of one or more instructions that cause the CPU feature to be executed by the second vCPU; and
causing the new workload to be executed by the second vCPU of the virtual machine after providing the instruction to disable the CPU feature and configuring the instruction intercept.

2. The computer-implemented method of claim 1, wherein causing the new workload to be executed comprises:
causing the new workload to be executed without restarting the virtual machine.

3. The computer-implemented method of claim 1, wherein the request is a first request, the existing workload is a first workload, and the new workload is a second workload, and
wherein the method further comprises:
detecting a second request associated with a third workload to be executed by the virtual machine,
wherein the third workload is to be executed with the CPU feature;
providing an instruction to enable the CPU feature on the second vCPU;
removing the instruction intercept to prevent execution of one or more instructions that cause the CPU feature to be executed; and
causing the third workload to be executed by the second vCPU of the virtual machine.

4. The computer-implemented method of claim 1, wherein the request is a first request, the existing workload is a first workload, and the new workload is a second workload, and
wherein the method further comprises:
detecting a second request associated with a third workload to be executed by the virtual machine,
wherein the new workload is to be executed with the CPU feature;
providing an instruction to enable the CPU feature on a third vCPU of the core; and
causing the third workload to be executed by the third vCPU.

5. The computer-implemented method of claim 1, further comprising:
adjusting a number of vCPUs associated with the virtual machine.

6. The computer-implemented method of claim 5, wherein adjusting the number of vCPUs comprises:
assigning the number of vCPUs to a number threshold of cores of the CPU.

7. The computer-implemented method of claim 1, wherein the CPU feature is an accelerator feature of an accelerator.

8. The computer-implemented method of claim 7, wherein the accelerator feature is included on the core.

9. The computer-implemented method of claim 7, wherein the accelerator feature is shared by multiple cores of the CPU.

10. A computer program product comprising:
one or more computer readable storage media, and program instructions collectively stored on the one or more computer readable storage media, the program instructions comprising:
program instructions to detect a request associated with a central processing unit (CPU) feature associated with a virtual CPU (vCPU) of a CPU,
wherein the CPU feature is associated with a virtual machine;
program instructions to disable the CPU feature on the vCPU and configure an instruction intercept to prevent execution of the CPU feature by the vCPU when the request indicates that the CPU feature is to be disabled;
program instructions to enable the CPU feature on the vCPU and remove an instruction intercept that prevents the execution of the CPU feature by the vCPU when the request indicates that the CPU feature is to be enabled; and
program instructions to adjust a number of vCPUs associated with the virtual machine.

11. The computer program product of claim 10, wherein the program instructions to detect the request comprise:
program instructions to detect a request to disable the CPU feature; and
program instructions to determine whether the CPU feature is to be disabled on a plurality of vCPUs that include the vCPU.

12. The computer program product of claim 10, wherein the program instructions to detect the request comprise:
program instructions to detect a request to enable the CPU feature; and
program instructions to identify a core, of the CPU, that includes the CPU feature.

13. The computer program product of claim 10, wherein the program instructions further comprise:
program instructions to determine whether the vCPU is to be instantiated on a core of the CPU based on a number of vCPUs currently instantiated on the core.

14. The computer program product of claim 13, wherein the program instructions further comprise:
program instructions to determine whether the number of vCPUs currently instantiated on the core satisfy a vCPU number threshold;
program instructions to instantiate the vCPU on the core based on determining whether the number of vCPUs currently instantiated on the core satisfy the vCPU number threshold; and
program instructions to enable the CPU feature on the vCPU after instantiating the vCPU.

15. The computer program product of claim 10, wherein the program instructions to adjust the number of vCPUs comprise:
program instructions to determine whether a number of vCPUs instantiated on a core satisfy a vCPU number threshold; and
program instructions to cause the virtual machine to be executed on a second core of the CPU based on the number of vCPUs satisfying the vCPU number threshold.

16. A system comprising:
a cloud management component to:
detect a request associated with a central processing unit (CPU) feature associated with a virtual CPU (vCPU) of a CPU,
wherein the CPU feature is associated with a virtual machine;
disable the CPU feature on the vCPU and configure an instruction intercept to prevent execution of the CPU feature by the vCPU when the request indicates that the CPU feature is to be disabled;
enable the CPU feature on the vCPU when the request indicates that the CPU feature is to be enabled; and
determine whether to adjust a number of vCPUs associated with the virtual machine.

17. The system of claim 16, wherein, to adjust the number of vCPUs, the cloud management component is to:
determine whether a number of vCPUs instantiated on the CPU satisfy a vCPU number threshold; and
cause the virtual machine to be executed on a second core of the CPU based on the number of vCPUs satisfying the vCPU number threshold.

18. The system of claim 17, wherein the CPU feature is an accelerator feature of an accelerator.

19. The system of claim 18, wherein the accelerator feature is included on a core.

20. The system of claim 16, wherein the cloud management component is to:
disable the CPU feature on the vCPU and configure the instruction intercept without restarting the virtual machine.
